(19) United States
(12) Patent Application Publication
(10) Pub. No.: US 2022/0152753 A1
(43) Pub. Date: May 19, 2022

(54) SYSTEM AND METHOD FOR FORMING FEATURES WITHIN COMPOSITE COMPONENTS USING A TUBULAR ELECTRODE

(71) Applicant: General Electric Company, Schenectady, NY (US)

(72) Inventors: Yuefeng Luo, Liberty Township, OH (US); Jacob Gregory Thiel, Springboro, OH (US); Allison Michelle Hanna, Asheville, NC (US); Herbert Chidsey Roberts, Middletown, OH (US)

(21) Appl. No.: 17/098,957

(22) Filed: Nov. 16, 2020

(51) Int. Cl. B23P 15/02; F02C 7/00

(52) U.S. Cl. CPC B23P 15/02; F05D 2230/00; F02C 7/00

(57) ABSTRACT

A system for forming features within composite components includes a tubular electrode extending along a longitudinal direction from a proximal end to a distal end. The distal end is, in turn, configured to be positioned relative to a machining surface of the composite component such that a spark gap is defined between the distal end and the machining surface. Furthermore, the tubular electrode further extends in a radial direction between an inner surface and an outer surface, with the inner surface defining a central passage configured to supply a dielectric fluid to the machining surface. The outer surface of the tubular electrode includes at least one a channel defined therein or a non-circular cross-sectional shape.

### FIELD

The present disclosure generally pertains to systems and methods for forming features within composite components, such as turbomachine components.

### BACKGROUND

A gas turbine engine generally includes a compressor section, a combustion section, and a turbine section. During operation, the compressor section progressively increases the pressure of air entering the engine and supplies this compressed air to the combustion section. The compressed air and a fuel mix within the combustion section and burn within a combustion chamber to generate high-pressure and high-temperature combustion gases. The combustion gases flow through a hot gas path defined by the turbine section before exiting the engine. In this respect, the turbine section converts energy from the combustion gases into rotational energy. The extracted rotational energy is, in turn, used to rotate one or more shafts, thereby driving the compressor section and/or a fan assembly of the gas turbine engine.

The turbine section includes a plurality of stator nozzles and rotor blades, which extract kinetic and/or thermal energy from the combustion gases flowing therethrough. In this respect, the turbine stator nozzles and rotor blades are in direct contact with the combustion gases. Thus, it is generally necessary to cool the turbine stator nozzles and rotor blades during operation of the gas turbine engine. For example, the rotor blades typically include cooling passages through which a coolant (e.g., air bled from the compressor) flows.

Many cooling passages are formed using electric discharge machining (EDM) methods. In such methods, electric sparks/discharges from an electrode and dielectric fluid remove material from the stator nozzle and rotor blade to form the cooling passages. EDM methods work well when forming passages in metallic rotor blades. However, challenges exist when using EDM methods to form passages in composite stator nozzles and rotor blades. For example, the low electrical conductivity of composite materials can result in an accumulation of removed composite material between the electrode and the side wall of the passage due to the limited discharging power and the inter-electrode gap. This accumulated composite debris may cause the electrode to decompose, embrittle, and break within the passage being formed. It is extremely difficult to remove a broken electrode from a small cooling passage. Furthermore, when the electric power supplied to the electrode is increased to compensate for the low electrical conductivity of the composite material, various defects (e.g., microcracks and/or pitting) may occur.

Accordingly, an improved method for forming features, such as cooling passages, within composite components would be welcomed in the technology.

### BRIEF DESCRIPTION

Aspects and advantages of the invention will be set forth in part in the following description, or may be obvious from the description, or may be learned through practice of the invention.

In one aspect, the present subject matter is directed to a system for forming features within composite components. The system includes a tubular electrode extending along a longitudinal direction from a proximal end to a distal end. The distal end is, in turn, configured to be positioned relative to a machining surface of the composite component such that a spark gap is defined between the distal end and the machining surface. Furthermore, the tubular electrode further extends in a radial direction between an inner surface and an outer surface, with the inner surface defining a central passage configured to supply a dielectric fluid to the machining surface. The outer surface of the tubular electrode includes at least one a channel defined therein or a non-circular cross-sectional shape.

In another aspect, the present subject matter is directed to a method of forming features within composite components. The method includes positioning a distal end of a tubular electrode relative to a machining surface of a composite component such that a spark gap is defined between the distal end and the machining surface. The tubular electrode, in turn, has an inner surface and an outer surface, with the inner surface defining a central passage configured to supply a dielectric fluid to the machining surface and the outer surface including at least one defining a channel or a non-circular cross-sectional shape. Furthermore, the method includes supplying an electric current to the tubular electrode to generate a plurality of sparks within the spark gap such that composite material is removed from the machining surface. Moreover, the method includes rotating the tubular electrode relative to the composite component. In addition, the method includes supplying a dielectric fluid through the central passage to the machining surface such that the dielectric fluid transports the removed composite material away from the machining surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of one embodiment of a gas turbine engine;

FIG. 2 is a simplified cross-sectional view of one embodiment of a system for forming features within composite components;

FIG. 3 is a cross-sectional view of one embodiment of a tubular electrode, particularly illustrating an outer surface of the electrode having a non-polygonal shape;

FIG. 4 is a cross-sectional view of another embodiment of a tubular electrode, particularly illustrating an outer surface of the electrode having a non-circular shape with a pair of curved portions;

FIG. 5 is a cross-sectional view of a further embodiment of a tubular electrode, particularly illustrating an outer surface of the electrode having a star shape;

FIG. 6 is a cross-sectional view of yet another embodiment of a tubular electrode, particularly illustrating an outer surface of the electrode defining a channel;

FIG. 7 is side view of the embodiment of the tubular electrode shown in FIG. 6, particularly illustrating the channel extending linearly from a proximal end of the electrode to a distal end of the electrode;

FIG. 8 is a side view of yet a further embodiment of a tubular electrode, particularly illustrating an outer surface of the electrode defining a channel extending helically around the electrode;

FIG. 9 is a flow diagram of one embodiment of a method for forming features within composite components;

FIG. 10 is a cross-sectional view of one embodiment of a tubular electrode positioned relative to a composite component before formation of a feature within the component;

FIG. 11 is a cross-sectional view of one embodiment of a tubular electrode positioned relative to a composite component after a portion of a feature within the component has been formed; and

FIG. 12 is an alternate cross-sectional view of the tubular electrode shown in FIG. 11.

Repeat use of reference characters in the present specification and drawings is intended to represent the same or analogous features or elements of the present invention.

### DETAILED DESCRIPTION

Reference now will be made in detail to exemplary embodiments of the presently disclosed subject matter, one or more examples of which are illustrated in the drawings. Each example is provided by way of explanation and should not be interpreted as limiting the present disclosure. In fact, it will be apparent to those skilled in the art that various modifications and variations can be made in the present disclosure without departing from the scope of the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components.

Furthermore, the terms “upstream” and “downstream” refer to the relative direction with respect to fluid flow in a fluid pathway. For example, “upstream” refers to the direction from which the fluid flows, and “downstream” refers to the direction to which the fluid flows.

Additionally, the terms “low,” “high,” or their respective comparative degrees (e.g., lower, higher, where applicable) each refer to relative speeds within an engine, unless otherwise specified. For example, a “low-pressure turbine” operates at a pressure generally lower than a “high-pressure turbine.” Alternatively, unless otherwise specified, the aforementioned terms may be understood in their superlative degree. For example, a “low-pressure turbine” may refer to the lowest maximum pressure turbine within a turbine section, and a “high-pressure turbine” may refer to the highest maximum pressure turbine within the turbine section.

In general, the present subject matter is directed to a system and method for forming features within composite components. As will be described below, the disclosed system and method may be used to form features (e.g., cooling passages) within composite gas turbine components (e.g., stator nozzles and rotor blades). In several embodiments, the system includes a tubular electrode extending in a longitudinal direction from a proximal end to a distal end and in a radial direction between an inner surface and an outer surface. The inner surface, in turn, defines a central passage extending through the electrode. Furthermore, the outer surface defines a channel and/or has a non-circular cross-sectional shape.

As mentioned above, the disclosed system is used to form a feature, such as a cooling passage, within a composite component. Specifically, in several embodiments, the distal end of the electrode is positioned relative to a machining surface of the composite component such that a spark gap is defined between the distal end and the machining surface. Moreover, electric current is supplied to the electrode to generate a series of sparks within the spark gap such that composite material is removed from the machining surface. Furthermore, the electrode is rotated about its center or longitudinal axis and relative to the composite component. Additionally, a dielectric fluid is supplied through the central passage to the machining surface such that the dielectric fluid transports the removed composite material away from the machining surface and deionizes a discharge spot after a spark, thereby forming the feature.

The channel and/or the non-circular shape of the outer surface of the tubular electrode provide one or more technical advantages. More specifically, as described above, the low electrical conductivity of composite materials (i.e., compared to metallic materials) may result in an accumulation of the removed composite debris between the electrode and the inner surface of the feature (e.g., the cooling passage). Such an accumulation of composite debris may, in turn, cause the electrode to decompose, embrittle, and break within the feature. However, the channel and/or the non-circular shape of the outer surface provide additional clearance (i.e., more clearance than a circular electrode or an electrode not having a channel) for the dielectric fluid to flush removed composite material out of the feature. As such, the channel and/or the non-circular shape of the outer surface allow increased material removal from the feature during machining without the defects (e.g., microcracks or pitting) associated with increasing the power supplied to the electrode.

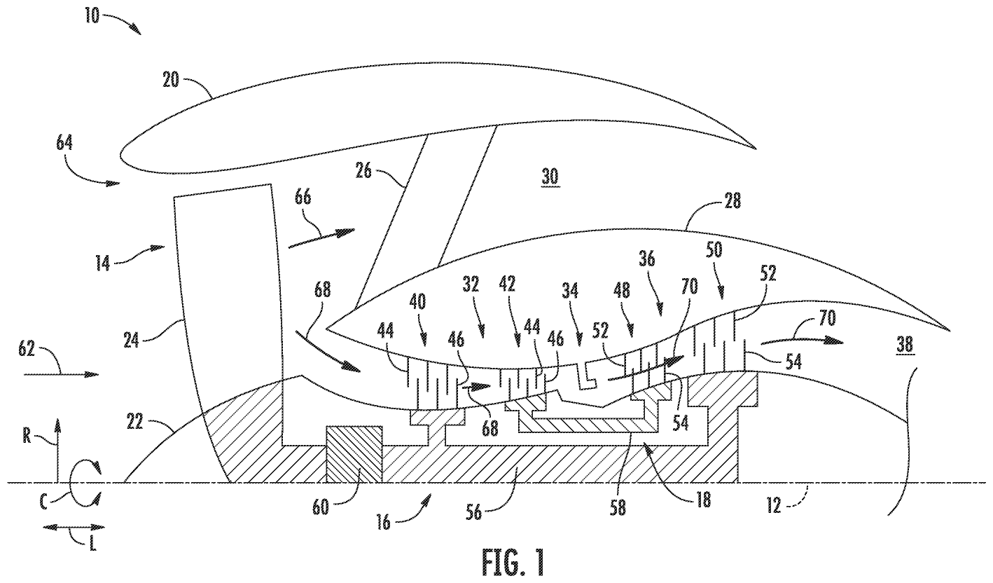

Referring now to the drawings, FIG. 1 is a schematic cross-sectional view of one embodiment of a gas turbine engine 10. In the illustrated embodiment, the engine 10 is configured as a high-bypass turbofan engine. However, in alternative embodiments, the engine 10 may be configured as a propfan engine, a turbojet engine, a turboprop engine, a turboshaft gas turbine engine, or any other suitable type of gas turbine engine.

In general, the engine 10 extends along an axial centerline 12 and includes a fan 14, a low-pressure (LP) spool 16, and a high pressure (HP) spool 18 at least partially encased by an annular nacelle 20. More specifically, the fan 14 may include a fan rotor 22 and a plurality of fan blades 24 (one is shown) coupled to the fan rotor 22. In this respect, the fan blades 24 are circumferentially spaced apart and extend radially outward from the fan rotor 22. Moreover, the LP and HP spools 16, 18 are positioned downstream from the fan 14 along the axial centerline 12. As shown, the LP spool 16 is rotatably coupled to the fan rotor 22, thereby permitting the LP spool 16 to rotate the fan 14. Additionally, a plurality of outlet guide vanes or struts 26 circumferentially spaced apart from each other and extend radially between an outer casing 28 surrounding the LP and HP spools 16, 18 and the nacelle 20. As such, the struts 26 support the nacelle 20 relative to the outer casing 28 such that the outer casing 28 and the nacelle 20 define a bypass airflow passage 30 positioned therebetween.

The outer casing 28 generally surrounds or encases, in serial flow order, a compressor section 32, a combustion section 34, a turbine section 36, and an exhaust section 38. For example, in some embodiments, the compressor section 32 may include a low-pressure (LP) compressor 40 of the LP spool 16 and a high-pressure (HP) compressor 42 of the HP spool 18 positioned downstream from the LP compressor 40 along the axial centerline 12. Each compressor 40, 42 may, in turn, include one or more rows of stator nozzles 44 interdigitated with one or more rows of compressor rotor blades 46. Moreover, in some embodiments, the turbine section 36 includes a high-pressure (HP) turbine 48 of the HP spool 18 and a low-pressure (LP) turbine 50 of the LP spool 16 positioned downstream from the HP turbine 48 along the axial centerline 12. Each turbine 48, 50 may, in turn, include one or more rows of stator nozzles 52 interdigitated with one or more rows of turbine rotor blades 54.

Additionally, the LP spool 16 includes the low-pressure (LP) shaft 56 and the HP spool 18 includes a high pressure (HP) shaft 58 positioned concentrically around the LP shaft 56. In such embodiments, the HP shaft 58 rotatably couples the rotor blades 54 of the HP turbine 48 and the rotor blades 46 of the HP compressor 42 such that rotation of the HP turbine rotor blades 54 rotatably drives HP compressor rotor blades 46. As shown, the LP shaft 56 is directly coupled to the rotor blades 54 of the LP turbine 50 and the rotor blades 46 of the LP compressor 40. Furthermore, the LP shaft 56 is coupled to the fan 14 via a gearbox 60. In this respect, the rotation of the LP turbine rotor blades 54 rotatably drives the LP compressor rotor blades 46 and the fan blades 24.

In several embodiments, the engine 10 may generate thrust to propel an aircraft. More specifically, during operation, air (indicated by arrow 62) enters an inlet portion 64 of the engine 10. The fan 14 supplies a first portion (indicated by arrow 66) of the air 62 to the bypass airflow passage 30 and a second portion (indicated by arrow 68) of the air 62 to the compressor section 32. The second portion 68 of the air 62 first flows through the LP compressor 40 in which the rotor blades 46 therein progressively compress the second portion 68 of the air 62. Next, the second portion 68 of the air 62 flows through the HP compressor 42 in which the rotor blades 46 therein continue progressively compressing the second portion 68 of the air 62. The compressed second portion 68 of the air 62 is subsequently delivered to the combustion section 34. In the combustion section 34, the second portion 68 of the air 62 mixes with fuel and burns to generate high-temperature and high-pressure combustion gases 70. Thereafter, the combustion gases 70 flow through the HP turbine 48 which the HP turbine rotor blades 54 extract a first portion of kinetic and/or thermal energy therefrom. This energy extraction rotates the HP shaft 58, thereby driving the HP compressor 42. The combustion gases 70 then flow through the LP turbine 50 in which the LP turbine rotor blades 54 extract a second portion of kinetic and/or thermal energy therefrom. This energy extraction rotates the LP shaft 56, thereby driving the LP compressor 40 and the fan 14 via the gearbox 60. The combustion gases 70 then exit the engine 10 through the exhaust section 38.

In several embodiments, one or more the components of the gas turbine engine 10 may be formed of a composite material, such as ceramic matrix composite (CMC) material. For example, in some embodiments, the compressor nozzles 44, the compressor blades 46, the turbine nozzles 52, and the turbine blades 54 may be formed from CMC materials. However, in alternative embodiments, any other suitable components of the engine 10 may be formed by composite materials.

The configuration of the gas turbine engine 10 described above and shown in FIG. 1 is provided only to place the present subject matter in an exemplary field of use. Thus, the present subject matter may be readily adaptable to any manner of gas turbine engine configuration, including other types of aviation-based gas turbine engines, marine-based gas turbine engines, and/or land-based/industrial gas turbine engines.

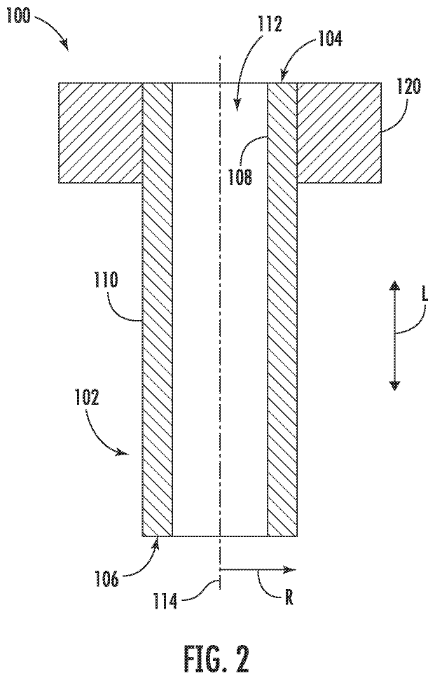

FIG. 2 is a simplified cross-sectional view of one embodiment of a system 100 for forming features within composite components. In general, the system 100 includes a tubular electrode 102 extending along a longitudinal direction L from a proximal end 104 to a distal end 106. The distal end 106 is, in turn, configured to be positioned relative to a composite component such that a spark gap is defined between the distal end 106 and the component. As will be described below, when an electric current is applied to the tubular electrode 102, a series of sparks is generated within the spark gap. Such sparks remove composite material from the composite component, thereby forming a feature (e.g., a passage or a hole) within the component. Moreover, the tubular electrode 102 extends in a radial direction R between an inner surface 108 and an outer surface 110. In some embodiments, the inner and outer surfaces 108, 110 have a constant radius. As used herein, the “radius” of the inner and outer surfaces 108, 110 refers to the distance extending from a longitudinal centerline 114 of the tubular electrode 102 to the inner/outer surface 108/110 in the radial direction R.

In several embodiments, the inner surface 108 of the tubular electrode 102 defines a central passage 112. More specifically, the central passage 112 extends through the center of the tubular electrode 102 in the longitudinal direction L from the proximal end 104 to the distal end 106 (i.e., along a longitudinal centerline 114 of the electrode 102). As such, the central passage 112 is configured to supply a dielectric fluid (e.g., deionized water or a non-conductive oil) to the spark gap. The dielectric fluid, in turn, flushes or otherwise transports the composite material removed by the sparks away from the spark gap and deionizes the discharged spots after the individual sparks. In some embodiments, the central passage 112 has a circular cross-sectional shape. However, in alternative embodiments, the central passage 112 may have any other suitable cross-sectional shape, such as the cross-sectional shape of the outer surface 110.

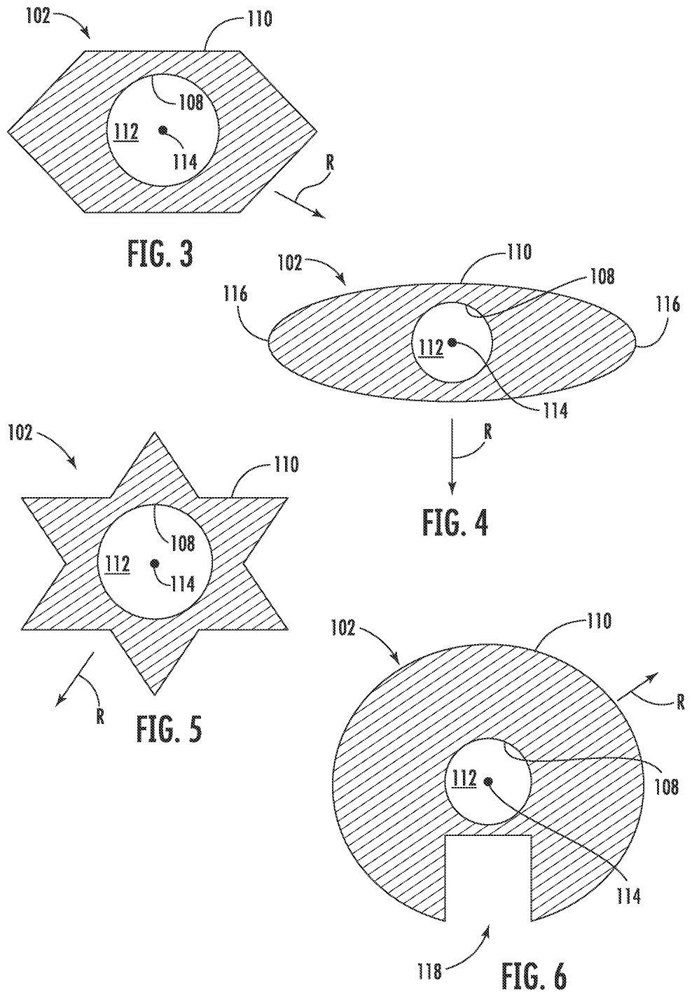

In several embodiments, the outer surface 110 of the tubular electrode 102 has a non-circular cross-sectional shape. In some embodiments, the outer surface 110 has a polygonal cross-sectional shape. For example, as shown in FIG. 3, in one embodiment, the outer surface 110 has a hexagonal cross-sectional shape. However, the outer surface 110 may have any other suitable polygonal cross-sectional shape. In other embodiments, the outer surface 110 has a non-circular cross-sectional shape having one or more curved portions. For example, as shown in FIG. 4, in one embodiment, the outer surface 110 has a pair of curved portions 116 such that the outer surface 110 has an oval cross-sectional shape. However, the outer surface 110 may have any other suitable non-circular cross-sectional shape having one or more curved portions. In other embodiments, the outer surface 110 has an irregular, non-circular cross-sectional shape. For example, as shown in FIG. 5, in one embodiment, the outer surface 110 has a star cross-sectional shape. However, the outer surface 110 may have any other suitable irregular, non-circular cross-sectional shape. Additionally, in alternative embodiments, the outer surface 110 may have any other suitable non-circular cross-sectional shape.

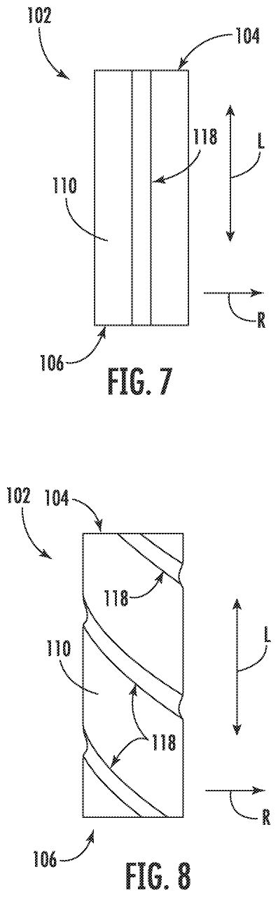

Additionally or alternatively, as shown in FIGS. 6-8, in several embodiments, the outer surface 110 of the tubular electrode 102 defines one or more channels 118. More specifically, the channel 118 may extend in the longitudinal direction L from the proximal end 104 of the tubular electrode 102 to the distal end 106 of the tubular electrode 102. As shown in FIG. 7, in one embodiment, the channel 118 extends linearly between the proximal and distal ends 106, 108. That is, in such an embodiment, the channel 118 has a constant circumferential position along the tubular electrode 102. As shown in FIG. 8, in another embodiment, the channel 118 extends helically around the tubular electrode 102 like the flutes of a drill bit. Although the embodiments shown in FIGS. 6-8 include only one channel 118, the outer surface 110 may define any other suitable number of channels 118, such as two or more channels 118.

In addition, the tubular electrode 102 may be formed of any suitable metallic material. For example, in several embodiments, the tubular electrode 102 is formed from copper or a copper alloy, such as brass.

Referring again to FIG. 2, the system 100 includes an actuator 120 coupled to the proximal end of the electrode 102. In this respect, the actuator 120 is configured to rotate the tubular electrode 102 about its longitudinal centerline 114. Such rotation of the tubular electrode 102, in turn, allows the electrode 102 to form a feature (e.g., a passage or hole) within the composite component having a circular cross-sectional shape despite the outer surface 110 of the electrode 102 having a non-circular cross-sectional shape and/or defining one or more channel(s) 118. In one embodiment, the actuator 120 is driven by an electric motor. However, in alternative embodiments, the actuator 120 may be driven by any other suitable device for rotating the tubular electrode 102 about its longitudinal axis 114.

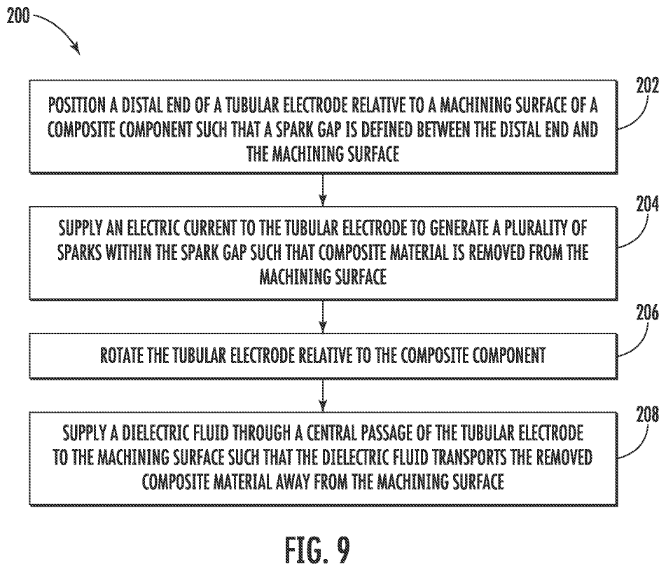

FIG. 9 is a flow diagram of one embodiment of a method 200 for forming features within composite components. In general, the method 200 will be discussed in the context of the system 100 described above and shown in FIGS. 1-8. However, the disclosed method 200 may be implemented within any system having any suitable configuration. In addition, although FIG. 9 depicts steps performed in a particular order, the disclosed methods are not limited to any particular order or arrangement. As such, the various steps of the disclosed methods can be omitted, rearranged, combined, and/or adapted in various ways without deviating from the scope of the present disclosure.

Moreover, the various steps of the method 200 will be described below in the context of forming a passage 302 (FIG. 11) within a composite component 300 (FIG. 11). For example, as will be described below, the composite component 300 may correspond to a composite component of the gas turbine engine 10. For example, in some embodiments, the composite component 300 may correspond to a compressor nozzle(s) 44, a compressor blade(s) 46, a turbine nozzle(s) 52, and/or a turbine blade(s) 54 of the engine 10. However, in alternative embodiments, the composite component 300 may correspond to any other suitable composite component. Furthermore, the method 200 may be used to form any other suitable feature within the composite component 300, such as a hole, a slot, a cavity, and/or the like.

Moreover, the composite component 300 may be formed from any suitable composite material. For example, the composite material may be selected from the group consisting of, but not limited to, a ceramic matrix composite (CMC), a polymer matrix composite (PMC), a metal matrix composite (MMC), or a combination thereof. Suitable examples of matrix material for a CMC include, but are not limited to, silicon carbide, aluminum-oxide, silicon oxide, and combinations thereof. Suitable examples of matrix material for a PMC include, but are not limited to, epoxy-based matrices, polyester-based matrices, and combinations thereof. Suitable examples of a matrix material for a MMC include, but are not limited to, aluminum, titanium, and combination thereof. For example, a MMC may be formed from powder metals such as, but not limited to, aluminum powder or titanium powder capable of being melted into a continuous molten liquid metal which can encapsulate fibers present in the assembly, before being cooled into a solid ingot with incased fibers. The resulting MMC is a metal article with increased stiffness, and the metal portion (matrix) is the primary load carrying element. For example, in one embodiment, the composite component 300 may be formed from a silicon carbide-silicon carbide (SiC-SiC) matrix composite.

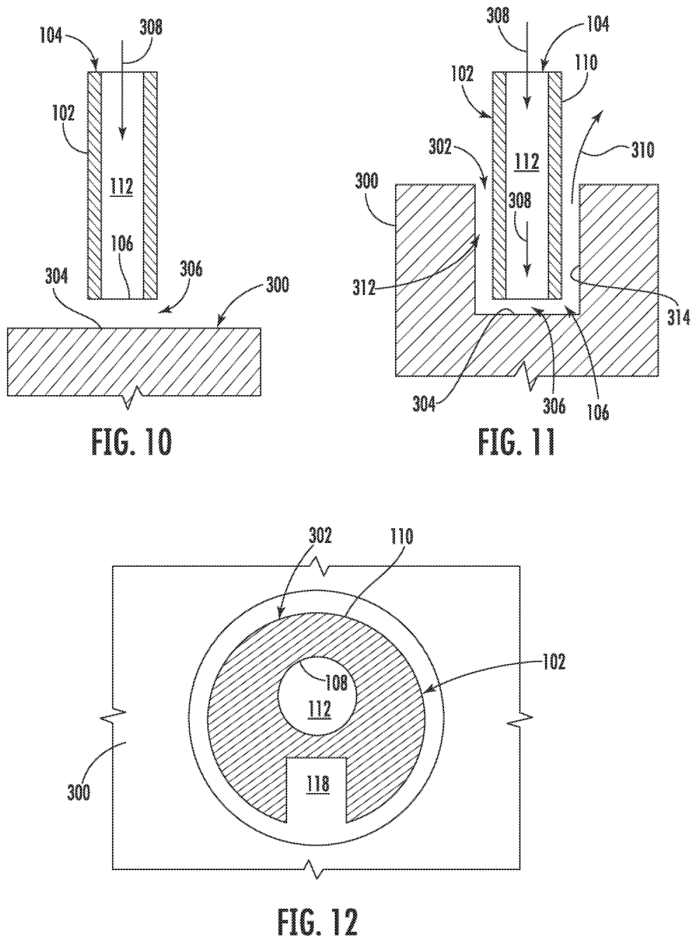

As shown in FIG. 9, at (202), the method 200 includes positioning a distal end of a tubular electrode relative to a machining surface of a composite component such that a spark gap is defined between the distal end and the machining surface. In several embodiments, as shown in FIG. 10, the distal end 106 of the tubular electrode 102 is positioned relative to a machining surface 304 of the composite component 300 such that a spark gap 306 is defined between the distal end 106 and the machining surface 304.

Additionally, as shown in FIG. 9, at (204), the method 200 includes supplying an electric current to the tubular electrode to generate a series of sparks within the spark gap such that composite material is removed from the machining surface. In several embodiments, an electric current is supplied to the tubular electrode 102 to generate a series of sparks within the spark gap 306. Specifically, the supplied electric current is discharged from the distal end 106 of the tubular electrode 102 in the form of a plurality of sparks that form a plasma channel between the distal end 106 and machining surface 304. The sparks, in turn, remove composite material from the machining surface 304 to form the passage 302.

Furthermore, at (206), the method 200 includes rotating the tubular electrode relative to the composite component. In several embodiments, the actuator 120 rotates the tubular electrode 102 about is longitudinal axis 114. Such rotation of the tubular electrode 102, in turn, results in the passage 302 having a circular cross-sectional shape despite the non-circular cross-sectional shape of the outer surface 110 of the electrode 102 and/or the outer surface 110 defining one or more channels 118.

Moreover, at (208), the method 200 includes supplying a dielectric fluid through the central passage to the machining surface such that the dielectric fluid transports the removed composite debris away from the machining surface and deionizes the discharged spot after each spark. In several embodiments, a dielectric fluid (indicated by arrow 308), such as deionized water or nonconductive oil, is supplied through central passage 112 of the tubular electrode 102 to the machining surface 304. The dielectric fluid 308 then transports the removed composite debris away from the machining surface 304 and deionizes the discharged spot after each spark. For example, as shown in FIG. 11, the mixture of the dielectric fluid 308 and the removed composite debris (indicated by arrow 310) flows out of the passage 302 through a clearance 312 defined between the outer surface 110 of the tubular electrode 102 and an inner surface 314 of the passage 302.

The channel(s) 118 defined by the outer surface 110 and/or the non-circular shape of the outer surface 110 of the tubular electrode 102 provides one or more technical advantages. More specifically, as described above, low electrical conductivity of composite materials (i.e., compared to metallic materials) may result in an accumulation of the removed composite material between an electrode and the inner surface of the feature (e.g., in the clearance 312) being formed. Such an accumulation of composite debris may, in turn, cause the electrode to decompose, embrittle, and break within the feature. However, as shown in FIG. 11, the channel(s) 118 defined by the outer surface 110 provide additional clearance for the dielectric fluid to flush the composite debris out of the feature. Additionally or alternatively, the non-circular shape of the outer surface 110 of the tubular electrode 102 similarly provides additional clearance for flushing the removed composite material out of the feature. As such, the channel(s) 118 defined by the outer surface 110 and/or the non-circular shape of the outer surface 110 allow increased material removal from a feature during machining (to prevent or reduce deterioration of the tubular electrode 102) without the defects (e.g., microcracks or pitting) associated with increasing the power supplied to the electrode 102.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A system for forming features within composite components, the system comprising: a tubular electrode extending along a longitudinal direction from a proximal end to a distal end, the distal end configured to be positioned relative to a machining surface of the composite component such that a spark gap is defined between the distal end and the machining surface, the tubular electrode further extending in a radial direction between an inner surface and an outer surface, the inner surface defining a central passage configured to supply a dielectric fluid to the machining surface, wherein the outer surface of the tubular electrode includes at least one a channel defined therein or a non-circular cross-sectional shape.

The system of one or more of these clauses, wherein the outer surface of the tubular electrode has a constant radius extending between the proximal end of the tubular electrode and the distal end of the tubular electrode.

The system of one or more of these clauses, wherein the outer surface of the tubular electrode includes the channel defined therein.

The system of one or more of these clauses, wherein the channel extends along the longitudinal direction from the proximal end of the tubular electrode to the distal end of the tubular electrode.

The system of one or more of these clauses, wherein the channel extends linearly from the proximal end of the tubular electrode to the distal end of the tubular electrode.

The system of one or more of these clauses, wherein the channel is helical.

The system of one or more of these clauses, wherein the outer surface of the tubular electrode includes the non-circular cross-sectional shape.

The system of one or more of these clauses, wherein the outer surface of the tubular electrode has a polygonal cross-sectional shape.

The system of one or more of these clauses, wherein the non-circular cross-sectional shape comprises a curved portion.

The system of one or more of these clauses, wherein the outer surface of the tubular electrode has a star shape.

The system of one or more of these clauses, further comprising: an actuator coupled to the proximal end of the tubular electrode, the actuator configured to rotate the tubular electrode about a longitudinal centerline of the tubular electrode.

The system of one or more of these clauses, wherein the tubular electrode is formed from copper or a copper alloy.

A method of forming features within composite components, the method comprising: positioning a distal end of a tubular electrode relative to a machining surface of a composite component such that a spark gap is defined between the distal end and the machining surface, the tubular electrode having an inner surface and an outer surface, the inner surface defining a central passage configured to supply a dielectric fluid to the machining surface, and the outer surface including at least one of a channel defined therein or a non-circular cross-sectional shape; supplying an electric current to the tubular electrode to generate a plurality of sparks within the spark gap such that composite material is removed from the machining surface; rotating the tubular electrode relative to the composite component; and supplying a dielectric fluid through the central passage to the machining surface such that the dielectric fluid transports the removed composite material away from the machining surface.

The method of one or more of these clauses, wherein the outer surface of the tubular electrode has a constant radius extending between a proximal end of the tubular electrode and the distal end of the tubular electrode.

The method of one or more of these clauses, wherein the outer surface of the tubular electrode includes the channel defined therein.

The method of one or more of these clauses, wherein the outer surface of the tubular electrode includes the non-circular cross-sectional shape.

The method of one or more of these clauses, wherein the composite component is formed from a ceramic matrix composite material.

The method of one or more of these clauses, wherein the ceramic matrix composite material is a silicon carbide-silicon carbide matrix material.

The method of one or more of these clauses, wherein the composite component is a gas turbine engine component.

The method of one or more of these clauses, wherein the tubular electrode is formed from copper or a copper alloy.

What is claimed is:

1. A system for forming features within composite components, the system comprising:
a tubular electrode extending along a longitudinal direction from a proximal end to a distal end, the distal end configured to be positioned relative to a machining surface of the composite component such that a spark gap is defined between the distal end and the machining surface, the tubular electrode further extending in a radial direction between an inner surface and an outer surface, the inner surface defining a central passage configured to supply a dielectric fluid to the machining surface,
wherein the outer surface of the tubular electrode includes at least one a channel defined therein or a non-circular cross-sectional shape.

2. The system of claim 1, wherein the outer surface of the tubular electrode has a constant radius extending between the proximal end of the tubular electrode and the distal end of the tubular electrode.

3. The system of claim 1, wherein the outer surface of the tubular electrode includes the channel defined therein.

4. The system of claim 3, wherein the channel extends along the longitudinal direction from the proximal end of the tubular electrode to the distal end of the tubular electrode.

5. The system of claim 4, wherein the channel extends linearly from the proximal end of the tubular electrode to the distal end of the tubular electrode.

6. The system of claim 4, wherein the channel is helical.

7. The system of claim 1, wherein the outer surface of the tubular electrode includes the non-circular cross-sectional shape.

8. The system of claim 7, wherein the outer surface of the tubular electrode has a polygonal cross-sectional shape.

9. The system of claim 7, wherein the non-circular cross-sectional shape comprises a curved portion.

10. The system of claim 7, wherein the outer surface of the tubular electrode has a star shape.

11. The system of claim 1, further comprising:
an actuator coupled to the proximal end of the tubular electrode, the actuator configured to rotate the tubular electrode about a longitudinal centerline of the tubular electrode.

12. The system of claim 1, wherein the tubular electrode is formed from copper or a copper alloy.

13. A method of forming features within composite components, the method comprising:
positioning a distal end of a tubular electrode relative to a machining surface of a composite component such that a spark gap is defined between the distal end and the machining surface, the tubular electrode having an inner surface and an outer surface, the inner surface defining a central passage configured to supply a dielectric fluid to the machining surface and the outer surface including at least one of a channel defined therein or a non-circular cross-sectional shape;
supplying an electric current to the tubular electrode to generate a plurality of sparks within the spark gap such that composite material is removed from the machining surface;
rotating the tubular electrode relative to the composite component; and
supplying a dielectric fluid through the central passage to the machining surface such that the dielectric fluid transports the removed composite material away from the machining surface.

14. The method of claim 13, wherein the outer surface of the tubular electrode has a constant radius extending between a proximal end of the tubular electrode and the distal end of the tubular electrode.

15. The method of claim 13, wherein the outer surface of the tubular electrode includes the channel defined therein.

16. The method of claim 13, wherein the outer surface of the tubular electrode includes the non-circular cross-sectional shape.

17. The method of claim 13, wherein the composite component is formed from a ceramic matrix composite material.

18. The method of claim 17, wherein the ceramic matrix composite material is a silicon carbide-silicon carbide matrix material.

19. The method of claim 13, wherein the composite component is a gas turbine engine component.

20. The method of claim 13, wherein the tubular electrode is formed from copper or a copper alloy.
